(19) United States
(12) Patent Application Publication
(10) Pub. No.: US 2014/0113153 A1
(43) Pub. Date: Apr. 24, 2014

(54) SUNSHADE TYPE OF DEVICE WITH A TRANSPARENT OR TRANSLUCENT FILM WHICH ALLOWS SUNLIGHT TO PASS BUT FILTERS OUT ULTRAVIOLET RAYS

(71) Applicant: SERNIS - FORMACAO E SOLUCOES TECNOLOGICAS, LDA., Braga (PT)

(72) Inventor: Fernando João Gonçalves Afonso, Braga (PT)

(73) Assignee: SERNIS - FORMACAO E SOLUCOES TECNOLOGICAS, LDA., Braga (PT)

(21) Appl. No.: 14/060,580

(22) Filed: Oct. 22, 2013

(30) Foreign Application Priority Data
Oct. 24, 2012 (PT) 10864

(51) Int. Cl. B32B 27/08

(52) U.S. Cl. CPC B32B 27/08
USPC 428/518

(57) ABSTRACT

This invention relates to a type of sunshade that has the distinctive feature of allowing sunlight and heat to pass, but prevents the passage of ultraviolet rays. The device, of conventional configuration, has a film consisting of three layers. Each layer consists of copolymers. Additives are added to these layers to absorb and stabilize ultraviolet rays. The invention allows the user, at the beach for example, to sunbathe and feel its warmth, while being protected from the damaging effects of ultraviolet rays.

### CROSS-REFERENCE TO RELATED APPLICATION

This application claims the benefit of the priority filing date of Portuguese Utility Model no. 10864 filed on Oct. 24, 2012. The earliest priority filing date claimed is Oct. 24, 2012.

### FEDERALLY SPONSORED RESEARCH

Not Applicable

### SEQUENCE LISTING OR PROGRAM

Not Applicable

### STATEMENT REGARDING COPYRIGHTED MATERIAL

Portions of the disclosure of this patent document contain material that is subject to copyright protection. The copyright owner has no objection to the facsimile reproduction by anyone of the patent document or the patent disclosure as it appears in the Patent and Trademark Office file or records, but otherwise reserves all copyright rights whatsoever.

### BACKGROUND

This is a sunshade device that has the distinctive feature of allowing almost all of the sunlight to pass through, but blocks most of the ultraviolet rays.

Almost paradoxically, it is not a sunshade in the technical sense. In fact, the invention does not block the sun in the sense of producing a shadow. The practical use of the invention lies in the fact that its user can be on the beach, enjoy “sun bathing”, and feel the warmth without being subject to harmful ultraviolet rays.

The invention uses a sheet of film, which would take the place of typical fabric used in conventional beach umbrellas (sunshades). The invention is made up of several layers that would incorporate substances known to filter or absorb ultraviolet rays.

Essentially, it is the application of a film, instead of fabric, to a beach umbrella's conventional structure at the manufacturing phase. A transparent or translucent film capable of absorbing ultraviolet rays and preventing them from reaching whomever is under its protection, thereby allowing its user to enjoy the sun's warmth.

Films for filtering ultraviolet and other types of radiation are already well known. The inventor has absolutely no knowledge of any type of transparent or translucent film with radiation-filtering, or radiation-absorption, features applied to a conventional sunshade in lieu of fabric, thereby allowing sunlight and heat to pass through but preventing harmful radiation from passing.

Naturally, this technique recognizes that there are similar devices that use plastic film. Moreover, they have the same transparency characteristic. These are ordinary umbrellas. They have, of course, none of the features related to protection against any kind of solar radiation.

### SUMMARY

This invention relates to a type of sunshade that has the distinctive feature of allowing sunlight and heat to pass, but prevents the passage of ultraviolet rays. The device, of conventional configuration, has a film consisting of three layers. Each layer consists of copolymers. Additives are added to these layers to absorb and stabilize ultraviolet rays. The invention allows the user, at the beach for example, to sunbathe and feel its warmth, while being protected from the damaging effects of ultraviolet rays.

### BRIEF DESCRIPTION OF THE DRAWINGS

FIG. 1 depicts the transparent film (1) being applied to the structure of the sunshade;

FIG. 2 depicts the structure of a conventional sunshade, with the film (1) already applied;

FIG. 3 shows a detailed, cross section of the film (1) having three layers consisting of: outer layers (1-a) and (1-c) comprised of polyethylene, and a core layer (1-b) comprised of a copolymer (Ethylene Vinyl Acetate, commonly known as EVA.

### BRIEF DESCRIPTION OF THE INVENTION

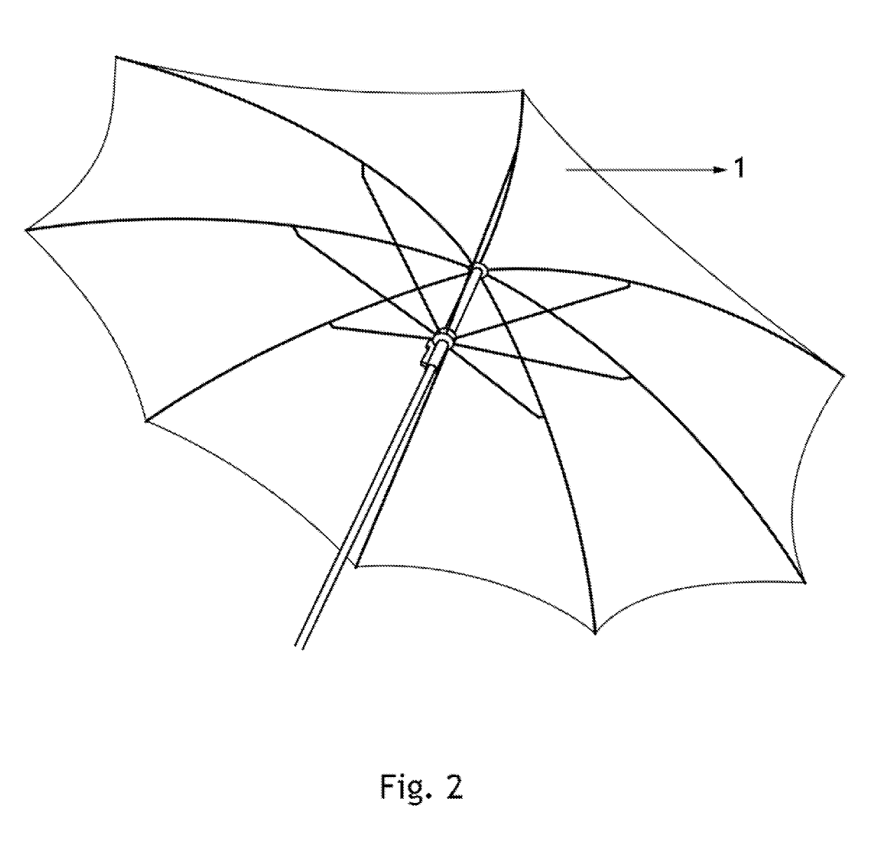

The invention starts with a conventional umbrella structure (FIG. 2). However, instead of using fabric during the manufacturing stage to perform its traditional function—providing shade—the cover consists of a transparent or translucent film (1).

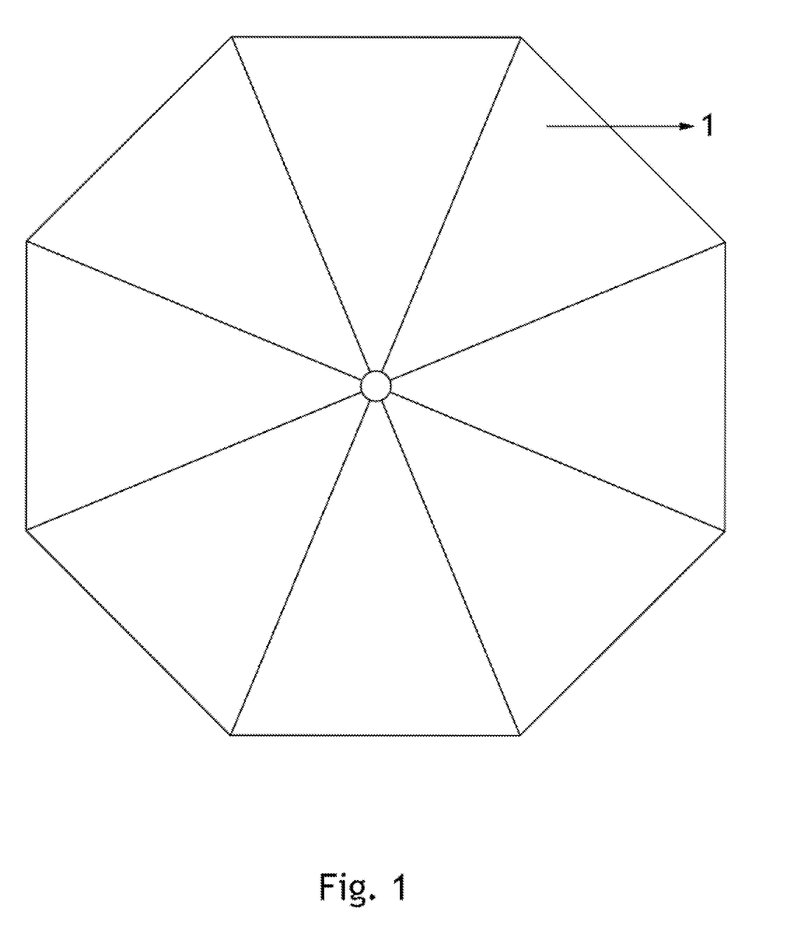

As depicted in FIG. 1, this film is stitched into sections, like conventional fabric for this type of sunshade.

Given that the purpose of the invention is to provide the user protection against the harmful effects of the sun—in the form of ultraviolet radiation—while allowing that person to enjoy the sun and its warmth, it is necessary to replace traditional fabric with a material that had filtration features or features for the absorption of ultraviolet rays.

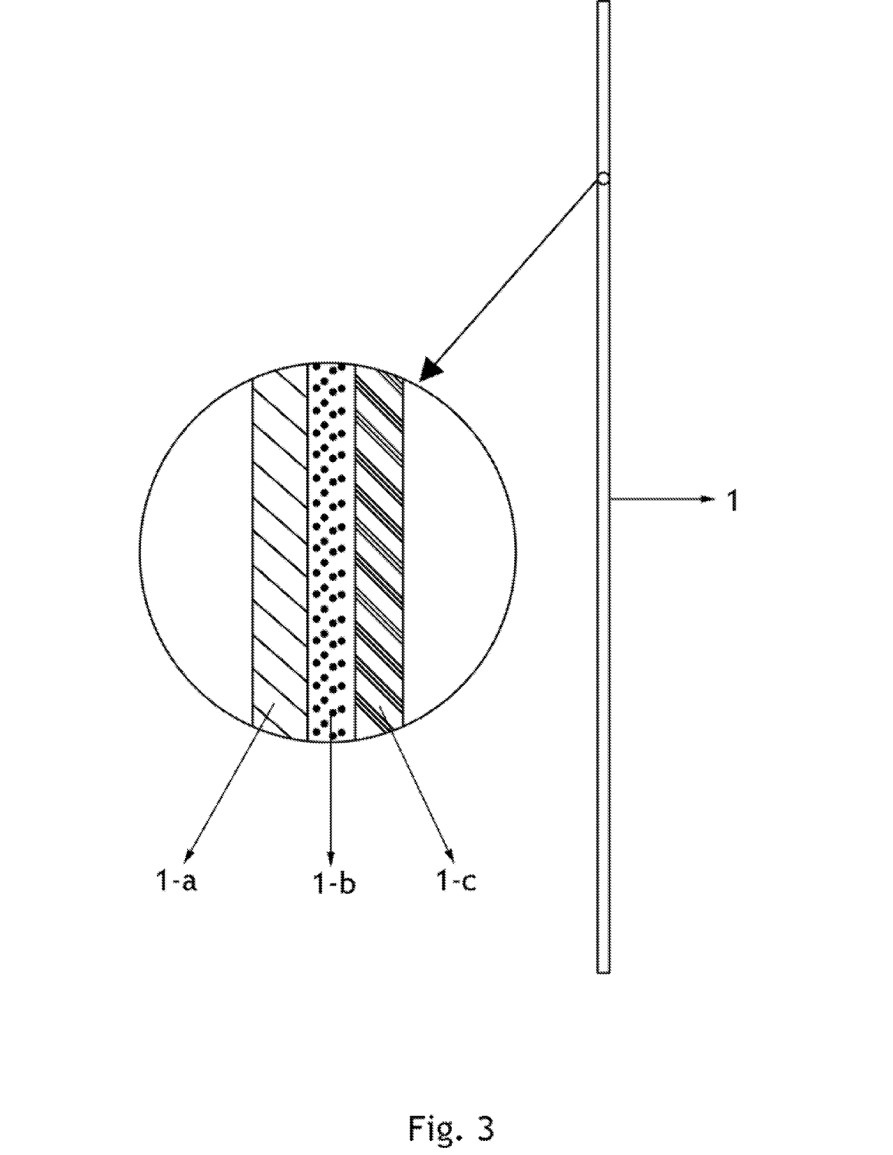

There are many products and substances on the market capable of significantly reducing, either by filtration or absorption, the impact of ultraviolet rays. The solution is to use a film composed of three layers of polymers (FIG. 3. This film is obtained through a process of co-extruding that combines three layers of different polymers into a single film.

The exterior layers of the film, (1-a) and (1-c), are polyethylene. This is responsible for preventing the viscosity of the film. The core layer (1-b) is a copolymer (Ethylene Vinyl Acetate), commonly known as EVA, and is responsible for the film's elasticity and absorption of infrared radiation. This copolymer is well known, and permits a wide variety of applications, being light and easily shaped (with “memory effect”).

Added to all layers of the film are additives of the SHA type (sterically hindered amines), which are used as stabilizers against UV radiation and its absorption, and benzophenone, one of the most widely used sunscreens. The greater or lesser amount of additives will determine the greater or lesser protection against ultraviolet radiation (the well known “protective factors” of sunscreens). This solution allows the possibility of using—and not just on the beach—sun shade type devices with different degrees or types of protection, making it possible, for example, to choose a device with protection factor X or Y.

As a result of the application of the three layers in the film (1), the film would exhibit the following features, in summary:

Transparency (or translucency), which allows the passage of sunlight and its warmth;
Flexibility (which facilitates its sewing and placement on the structure of the sunshade);
Protection against ultraviolet radiation, and this protection may be more or less intense.

What is claimed:

1. A sunshade type of device with a transparent or translucent film which allows sunlight to pass but filters out ultraviolet rays comprised of a covering, which, instead of woven material, is constituted by a transparent or translucent film consisting of three layers of copolymers joined through co-extrusion into a single film, sun protection additives also being added to these three layers.

2. The sunshade type of device with a transparent or translucent film which allows sunlight to pass but filters out ultraviolet rays of claim 1, wherein a first layer (1-a) and a third layer (1c), being exterior layers, consists of polyethylene, while a second layer (1-b), being an interior layer, consists of Ethylene Vinyl Acetate.

3. The sunshade type of device with a transparent or translucent film which allows sunlight to pass but filters out ultraviolet rays of claim 2, wherein sterically hindered amines and benzophenone derivatives are added to the three layers (1-a), (1-b) and (1-c) which form the film.
